(19) United States
(12) Patent Application Publication
(10) Pub. No.: US 2025/0178286 A1
(43) Pub. Date: Jun. 5, 2025

(54) ANTI-WARPING AID FOR FABRICATION OF PHYSICAL OBJECTS

(71) Applicant: MANTLE INC., San Francisco, CA (US)

(72) Inventors: Mohammed Haouaoui, Richmond, CA (US); Juan Moreno, San Francisco, CA (US); Stephen T. Connor, San Francisco, CA (US); Fabio Zurcher, Brisbane, CA (US)

(73) Assignee: MANTLE INC., San Francisco, CA (US)

(21) Appl. No.: 18/961,177

(22) Filed: Nov. 26, 2024

Related U.S. Application Data
(60) Provisional application No. 63/604,241, filed on Nov. 30, 2023.

(51) Int. Cl. B29C 64/40; B33Y 40/00

(52) U.S. Cl. CPC B29C 64/40; B33Y 40/00

(57) ABSTRACT

An anti-warping layer and systems and methods for employing such. The anti-warping layer having a mobile and/or lubricious characteristics configured to reduce warpage of a fabricated physical object when the fabricated physical object is subjected to volumetric change inducing treatments.

### CROSS-REFERENCE TO RELATED APPLICATIONS

This application claims the benefit of U.S. Provisional Patent Application No. 63/604,241, filed on Nov. 30, 2023, which is hereby incorporated by reference in its entirety.

### TECHNICAL FIELD

The present teachings relate generally to the fabrication of physical objects and, more particularly, to mitigating the risk of warpage of a physical object during treatments that induce a volumetric change of the physical object.

### BACKGROUND

In conventional methods for the fabrication of some physical objects or parts, the physical object or part or a portion thereof is fabricated according to any number of known fabrication techniques and is then subjected to a treatment that induces a volumetric change of the physical object or part. Such treatments may, for example, include thermal or heat treatments of the physical object or part that result in removal of certain components of the material from which the physical object or part is formed, e.g., a debinding treatment, or the fusing of the components of the material from which the physical object or part is formed, e.g., a sintering treatment. Alternatively, a volumetric change of a physical object may occur due to a chemical reaction, for example, a volumetric loss due to the reaction of a metal hydroxide to a metal oxide or a volumetric gain or expansion due to a reaction of a metal to a metal oxide.

For example, additive or three-dimensional (3D) printing of physical objects involves the formation of a physical object or part through, for example, the extrusion, jetting, or printing of a material, for example a paste or a powder, on to a surface of a support, plate, or stage. The formation of the physical object or part may proceed in a more or less radial manner away from a central initiation point or may proceed in a more or less horizontal layer-by-layer fashion. Once the physical object or part has been formed, depending upon the composition of the material employed, the physical object may further be subjected to one or more treatments that induce a volumetric change in the physical object or part such as a debinding, sintering treatment, chemical reaction, and/or a combination thereof. In some instances, subsequent to the volumetric change inducing treatment or treatments, the physical object or part is further subjected to additional processing steps such as fine surface finishing, drilling, and electrical discharge machining. Exemplary techniques and systems for the fabrication of physical objects are described in U.S. Pat. Nos. 10,087,332, 10,520,923; 10,807,162; 11,306,968; and U.S. Pub. Nos.: 2022/0097190; 2022/0331873; 2022/0339703; 2023/0057940; which are each herein incorporated by reference in their entireties.

For the sake of clarity, the term “semifinished” physical object or part will be used herein to refer to a fabricated physical object or part that requires further treatment or treatments that may induce a volumetric change in the physical object or part. After such volumetric changing treatment or treatments have been performed on the physical object or part, the physical object or part will be referred to as a “finished” physical object or part.

During the volumetric change inducing treatment or treatments, the physical object or part may rest directly upon a support, plate, or stage or may rest or be bound to a support, plate, or stage by a material interposed between the bottom surface of the physical object or part and the upper surface of the support, plate, or stage. The same support, plate, or stage upon which the semifinished physical object or part is formed may or may not be the same support, plate, or stage upon which the physical object or part rests during the volumetric change inducing treatment or treatments.

Depending upon the composition of the material from which the physical object or part was formed, the volumetric change inducing treatment or treatments may cause the physical object or part to, for example, shrink. To ensure that the desired sized and shaped finished physical object or part is achieved after the volumetric change inducing treatment or treatments, various pre-fabrication techniques, e.g., digital or virtual object manipulation and processing, have been developed. However, generally speaking, such pre-fabrication shrinkage, or other volumetric change, compensation techniques fail to address the existing problem of warpage or asymmetric shrinkage of the semifinished physical object or part due in part to, for example, differential friction experienced by the physical object or part during the volumetric change inducing treatment or treatments.

For example, there exists (i) a first friction between a bottom surface of the physical object or part and the upper surface of the support, plate, or stage upon which the physical object or part rests during the volumetric change inducing treatment or treatments and (ii) a second, different friction between those surfaces of the physical object or part not in contact with the support, plate, or stage upon which the physical object or part rests during the volumetric change inducing treatment or treatments and the surrounding air or atmosphere. Alternatively stated, warpage or asymmetric shrinkage of the physical object or part may occur during the volumetric change inducing treatment or treatments due to the interface of the surface of the physical object or part and the surrounding air experiencing less friction relative to the friction experienced at the interface of the surface of the physical object resting upon the support, plate, or stage and the support, plate, or stage. The same asymmetric shrinkage may also be seen in situations in which a bonding material is interposed between the bottom surface of the physical object or part and the upper surface of the support, plate, or stage. Accordingly, there exists a need in the field to prevent or reduce the likelihood of warpage or asymmetric shrinkage during volumetric change inducing treatment or treatments of physical objects or parts.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

An anti-warping layer comprising a mobile and/or lubricious layer formed of one or more materials interposed between a bottom surface of a semifinished physical object and the top surface of a support upon which the bottom surface of the semifinished physical object rests.

Wherein the mobile and/or lubricious layer is formed of one of more materials comprises a plurality of balls.

Wherein the plurality of balls is arranged in a monolayer within the mobile and/or lubricious layer. Wherein the plurality of balls physically supports the semifinished physical object on the top surface of the support. Wherein the plurality of balls rests directly upon the top surface of the support and the bottom surface of a semifinished physical object rests directly upon the plurality of balls.

Wherein the plurality of balls comprises like-sized balls. Wherein the plurality of balls has an average diameter in a range of, 0.1 to 2.0 millimeters, 0.1 to 1.0 millimeters, 0.1 to 0.8 millimeters, 0.2 to 0.8 millimeters, 0.2 to 0.6 millimeters, 0.2 to 0.3 millimeters, 0.3 to 0.4 millimeters, 0.4 to 0.6 millimeters, or 0.4 to 0.5 millimeters. Wherein a variability in the diameter of the individual balls of the plurality of balls 24 is where 95 percent by weight of the individual balls of the plurality of balls have a diameter of plus or minus 0.05 millimeters or less.

Wherein the individual balls of the plurality of balls are formed of or coated with a material that is mechanically, chemically, and thermally stable and/or chemically inert. Wherein the individual balls of the plurality of balls are formed of or coated with a material comprising zirconium dioxide, yttria-stabilized zirconia, ceria-stabilized zirconia, yttria, aluminum oxide, silicon dioxide, calcium oxide, carbon, graphite, silicon carbide, tungsten carbide, boron nitride, porcelain and/or combinations thereof.

Wherein the mobile and/or lubricious layer formed of one of more materials comprises the plurality of balls and a stabilizer that is in contact with the plurality of balls and that limits movement of the individual balls of the plurality of balls relative to one another.

Wherein the stabilizer comprises a composition that decomposes or melts at temperatures lower than a temperature of a volumetric change inducing treatment of the semifinished physical object. Wherein the stabilizer comprises a composition that decomposes at temperatures lower than a decomposition temperature of a binder employed in the material from which the semifinished physical object is formed. Wherein the stabilizer comprises a composition that decomposes at a temperature ranging from 150 degrees Celsius to 400 degrees Celsius. Wherein the stabilizer comprises a composition that melts at a temperature ranging from 25 degrees Celsius to 400 degrees Celsius. Wherein the stabilizer comprises a composition comprising polycarbonates, poly(ethylene carbonate), poly(propylene carbonate), (poly)acrylic acid; polyethylene glycol; polyvinyl alcohol; ethyl cellulose; adhesives, glues (including glue stick) and/or combinations thereof. Wherein the stabilizer comprises a composition that produces little or no ash upon decomposition.

Wherein the stabilizer forms a thickness that is less than half of an average diameter of the plurality of balls; less than a quarter of an average diameter of the plurality of balls; less than a fifth of the average diameter of the plurality of balls; or less than a tenth of the average diameter of the plurality of balls. Wherein the stabilizer forms a complete or partial coating on the surface of the individual balls of the plurality of balls. Wherein the stabilizer forms a thickness substantially equal to an average diameter of the plurality of balls. Wherein the stabilizer forms a thickness greater than an average diameter of the plurality of balls.

An anti-warping system for formation of a finished physical object comprising a support having a top surface and an anti-warping layer arranged on the top surface of the support.

Wherein the top surface of the support comprises a substantially flat planer surface. Wherein the top surface of the support comprises a perimeter that forms a lip that is elevated above an internal flat planar portion of the top surface of the support. Wherein the support comprises ceramics, nonferrous metal, ferrous metal, graphene, carbon fiber composites, carbon fiber-reinforced carbon, molybdenum, nickel superalloys and/or combinations thereof.

Wherein the anti-warping layer is as described in any of the above examples. Wherein the anti-warping layer is arranged on the interior flat planar portion of the top surface of the support surrounded by the elevated lip.

A method for minimizing warpage of a physical object during a volumetric change inducing treatment comprising forming an anti-warping layer; arranging the anti-warping layer on an upper surface of a support; placing a semifinished physical object upon an upper surface of the anti-warping layer; and subjecting the semifinished physical object to a volumetric change inducing treatment while resting upon the anti-warping layer and the support.

Wherein the step of forming the anti-warping layer and the step of arranging the anti-warping layer on the upper surface of a support are executed sequentially. Wherein the step of forming the anti-warping layer and the step of arranging the anti-warping layer on the upper surface of a support are executed substantially concurrently.

Wherein the anti-warping layer is as described in any of the above examples.

Wherein the step of forming the anti-warping layer further comprises casting, spreading, spraying, or coating a stabilizer on to a surface and arranging a plurality of balls within the stabilizer. Wherein the step of forming the anti-warping layer further comprises arranging a plurality of balls over a surface and casting, spreading, spraying, or coating a stabilizer over the plurality of balls. Wherein the step of forming the anti-warping layer further comprises casting or extruding a suspension comprising a stabilizer and a plurality of balls over a surface.

Wherein the step of forming the anti-warping layer and the step of arranging the anti-warping layer on the upper surface of a support are executed concurrently and further comprise application of a layer of an adhesive or glue over a surface of the support and arrangement of the plurality of balls over the layer of the adhesive or glue.

Wherein the step of subjecting the semifinished physical object to a volumetric change inducing treatment comprises subjecting the semifinished physical object to a thermal treatment.

A method for minimizing warpage of a physical object during a volumetric change inducing treatment comprising forming an anti-warping layer; arranging the anti-warping layer on an upper surface of a support; forming a semifinished physical object upon an upper surface of the anti-warping layer; and subjecting the semifinished physical object to a volumetric change inducing treatment while resting upon the anti-warping layer and the support.

Wherein the anti-warping layer is as described in any of the above examples. Wherein the step of forming the anti-warping layer is as described in any of the above examples.

Wherein the step of forming the anti-warping layer further comprises forming a thickness of the stabilizer that is greater than an average diameter of the plurality of balls and removing a portion of the thickness to form a smooth, planar upper surface of the anti-warping layer upon which the semifinished physical object will be formed.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 is a diagram of a method for fabricating a physical object according to the present invention.

FIG. 2 is a diagram of a method for fabricating a physical object according to the present disclosure.

FIG. 3 is an elevation view of a physical object upon a support within a treatment apparatus according to the present disclosure.

FIG. 4 is plan view of a physical object upon a support within a treatment apparatus according to the present disclosure.

FIG. 5 is a cross-sectional elevation view along plane A of FIG. 4 of a physical object upon a support within a treatment apparatus according to the present disclosure.

FIG. 6 is a plan view of an anti-warping layer upon a support according to the present disclosure.

FIG. 7 is an elevation view of an anti-warping layer upon a support according to the present disclosure.

FIG. 8 is a plan view of an anti-warping layer upon a support according to the present disclosure.

FIG. 9 is a cross-sectional elevation view along plane B of FIG. 8 of an anti-warping layer upon a support according to the present disclosure.

FIG. 10 is an elevation view of an anti-warping layer upon a support according to the present disclosure.

FIG. 11 is an elevation view of an anti-warping layer upon a support according to the present disclosure.

FIG. 12 is a diagram of a method for fabricating a physical object according to the present disclosure.

FIG. 13 is an elevation view of an anti-warping layer supporting a portion of a physical object upon a support according to the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

For the sake of clarity, the use herein of the terms “physical object” and “part” are synonymous and interchangeable and are not intended to delineate an object formed of a specific material or class of materials and are not intended to delineate an object fabricated by a specific method or process. The use herein of the terms “support”, “plate”, and “stage” are also synonymous and interchangeable and are not intended to delineate an object or objects having a specific design, functionality, or utility beyond that of supporting a physical object or part and are not intended to delineate an object formed of a specific material or class of materials and are not intended to delineate an object fabricated by a specific method or process.

### Method 100

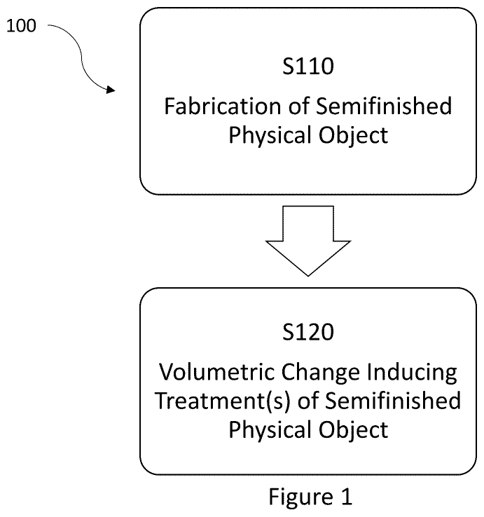

FIG. 1 illustrates a method 100 for fabrication of a physical object or part. Exemplary method 100 employs, in part, steps: S110, fabrication of a semifinished physical object and S120, volumetric change inducing treatment(s) of semifinished fabricated physical object.

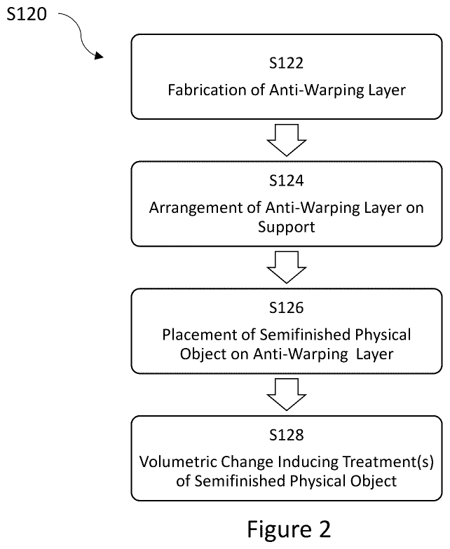

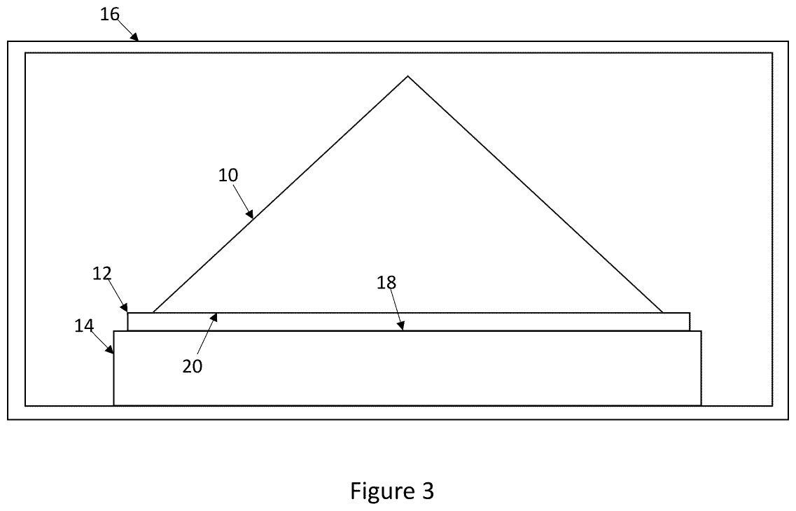

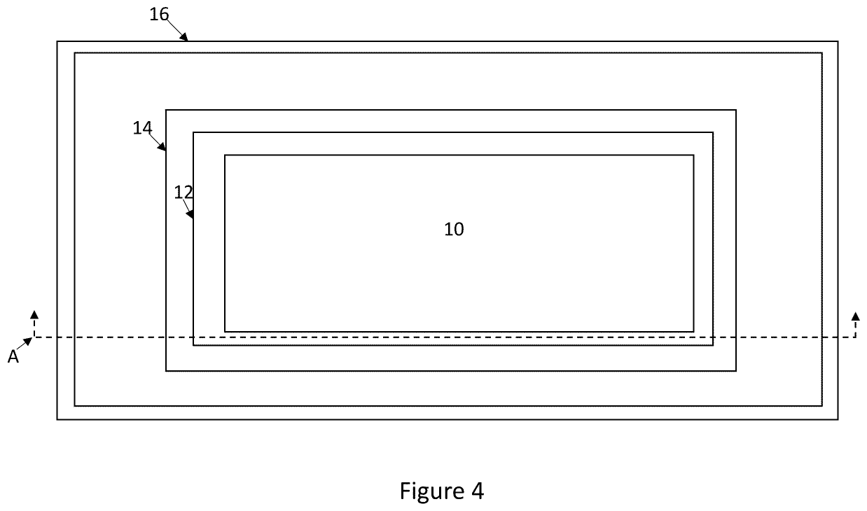

As shown in FIGS. 2 through 11, in certain examples of the present disclosure, step S120 further functions to execute steps: S122 for fabrication of an anti-warping layer 12; S124 for arrangement of the anti-warping layer on support 14; S126 for placement of a semifinished physical object 10 (resulting from step S110 of method 100) upon the anti-warping layer 12; and S128 for the volumetric change inducing treatment or treatments of the semifinished physical object 10.

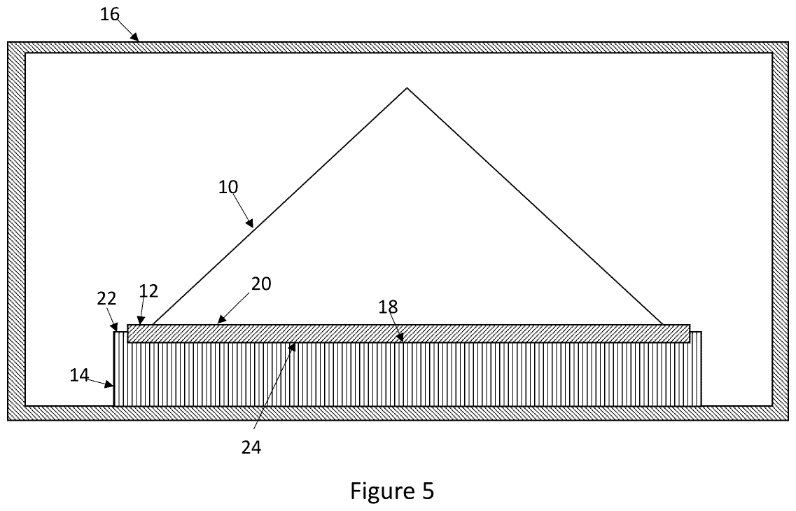

The support 14 functions, in part, to support or hold the physical object 10 during the volumetric change inducing treatment or treatments performed, for example, within a treatment apparatus 16. The treatment apparatus 16 is, for example, a furnace. The support 14 additionally and/or alternatively functions to modify the airflow and temperature profile within the treatment apparatus 16. During the volumetric change inducing treatment or treatments, a bottom surface 20 of one or more physical objects 10 are supported on a preferably flat planer, upper surface 18 of the support 14. The anti-warping layer 12 is interposed between the bottom surface 20 of the physical object 10 and the upper surface 18 of the support 14. In certain examples, as shown in FIG. 5, a perimeter of the support 14 forms a lip 22 or is otherwise elevated above an interior portion of the upper surface 18 of the support 14. In such examples, the anti-warping layer 12 occupies some or all of a depth of the depression formed by the interior portion relative to the lip 22 of the upper surface 18 of the support 14.

The support 14 is made of ceramics (e.g., alumina, zirconia, yttria-stabilized zirconia, silica, silicon carbide, tungsten carbide, boron nitride, porcelain, etc.), nonferrous metal, ferrous metal (e.g., steel), graphene, carbon fiber composites (CFC), carbon fiber-reinforced carbon (CFRC), molybdenum, nickel superalloys, combinations thereof and/or any other suitable material. The support 14 is preferably modular relative to the apparatus in which the volumetric change treatment or treatments are performed and/or the system in which the physical object 10 is fabricated, e.g., the support 14 can be inserted into and removed from such apparatus or system. However, the support 14 can alternatively be permanently secured to the apparatus in which the volumetric change treatment or treatments are performed, and/or the support 14 can be connected to the apparatus in which the volumetric change treatment or treatments are performed in any suitable manner. The support 14 may be supported on one or more stands or support bases that can be freestanding, part of the apparatus in which the volumetric change treatment or treatments are performed, part of the support 14, and/or otherwise constructed. The support(s) 14 can be arranged to divide the interior volume of the apparatus in which the volumetric change treatment or treatments are performed into equal or unequal spaces.

The anti-warping layer 12 functions to provide a mobile layer and/or lubricious, reduced friction interface between the bottom surface 20 of the physical object 10 and the upper surface 18 of the support 14 during the volumetric change treatment or treatments. Hence, the anti-warping layer 12 advantageously reduces or eliminates warpage of the semifinished physical object during the volumetric change treatment or treatments.

With reference to FIGS. 5 through 11 and 13, the anti-warping layer 12 employs, in part, a plurality a of like-sized, spherical beads or balls 24. For the sake of clarity, the balls 24 shown in the figures of the present application are not shown to scale relative to the other components of the present disclosure. The balls 24 of the anti-warping layer 12 are preferably oriented or arranged in a monolayer within the anti-warping layer 12. Accordingly, the plurality of balls 24 function, in part, as a structural support within the anti-warping layer 12 between the bottom surface 20 of the physical object 10 and the upper surface 18 of the support 14.

The individual balls 24 arranged within the anti-warping layer 12 are preferably in physical contact with adjacently arranged balls 24 to maximize the number of balls 24 within the anti-warping layer 12. Alternatively, the individual balls 24 arranged within the anti-warping layer 12 are not consistently in physical contact with adjacently arranged balls 24 and therefore form a random, unordered arrangement or distribution of the balls 24 within the anti-warping layer 12.

The plurality of balls 24 preferably have an average diameter in a range of, for example, 0.1 to 2.0 millimeters, 0.1 to 1.0 millimeters, 0.1 to 0.8 millimeters, 0.2 to 0.8 millimeters, 0.2 to 0.6 millimeters, 0.2 to 0.3 millimeters, 0.3 to 0.4 millimeters, 0.4 to 0.6 millimeters, or 0.4 to 0.5 millimeters. A variability in the diameter of the individual balls of the plurality of balls 24 being, for example, where 95 percent by weight of the individual balls of the plurality of balls have a variability in diameter of plus or minus 0.05 millimeters or less.

Preferably, the balls 24 are formed of a material and/or employ a coating of a material or materials that are characterized as being mechanically, chemically, and thermally stable in the temperature range of the volumetric change inducing treatment or treatments in which they are employed; chemically inert relative to physical object 10 and support 14 in the temperature range of the volumetric change inducing treatment or treatments in which they are employed; and lubricious. The balls 24 can be formed of and/or coated with, for example, zirconium dioxide (zirconia), yttria-stabilized zirconia (YSZ), ceria-stabilized zirconia (CSZ), yttria, aluminum oxide, silicon dioxide, calcium oxide, carbon, graphite, silicon carbide, tungsten carbide, boron nitride, porcelain and/or combinations thereof.

In order to temporarily stabilize or minimize movement of the balls 24 of anti-warping layer 12 on the support 14 during movement of the support 14, for example, movement of the support 14 into and out from the treatment apparatus 16, i.e. in order to minimize movement of the balls 24 prior to volumetric change treatment or treatments, the anti-warping layer 12 further employs a stabilizer 26. The stabilizer 26 limits mobility or movement of the balls 24 prior to the volumetric change inducing treatment or treatments but allows for movement and/or rotation of the balls 24 during the volumetric change inducing treatment or treatments. In one example, the stabilizer 26 is formed of a composition that decomposes in an inert atmosphere at temperatures lower than the temperature of the volumetric change inducing treatment or treatments of the physical object. For example, the stabilizer can be formed of a composition that decomposes at temperatures lower than the decomposition temperature of a binder or binders employed in the material from which the physical object is formed, for example decomposes at a temperature ranging from 150 degrees Celsius to 400 degrees Celsius. Furthermore, the stabilizer 26 is preferably formed of a composition that produces little or no ash upon decomposition, i.e., a material having a relatively low carbon content.

In an alternative example, the stabilizer 26 is formed of a composition that does not necessarily decompose but rather melts or sufficiently liquifies at temperatures lower than the temperature of the volumetric change inducing treatment or treatments of the physical object to allow for movement of the balls 24 during the volumetric change inducing treatment or treatments. For example, the stabilizer 26 is formed of a composition that melts or sufficiently liquifies at temperatures lower than the decomposition temperature of a binder or binders employed in the material from which the physical object is formed, for example melts or sufficiently liquifies at a temperature ranging from 25 degrees Celsius to 400 degrees Celsius.

In yet another example, the stabilizer 26 is preferably formed of a composition that does not substantially decompose or melt and the desired anti-warping characteristic is achieved by the reduced friction achieved by the physical object resting directly upon or disposed over the balls 24 during the volumetric change inducing treatment or treatments rather than by movement of the balls 24 during the volumetric change inducing treatment or treatments.

The stabilizer 26 can be formed of any composition having the above described characteristics and that provides sufficient adhesion to resist or prevent movement of the balls 24 relative to one another and to the support 14. By way of nonlimiting example, stabilizer 26 can be formed of compositions, such as, polycarbonates, poly (ethylene carbonate) (e.g. QPAC® 25), poly(propylene carbonate) (e.g., QPAC@ 40), (poly)acrylic acid (PAA), polyethylene glycol (PEG), polyvinyl alcohol (PVA), ethyl cellulose (EC), adhesives, glues (e.g. glue stick), other similar and dissimilar compounds capable of bonding or adhering to either one or both of the balls 24 and the upper surface 18 of the support 14; and combinations thereof.

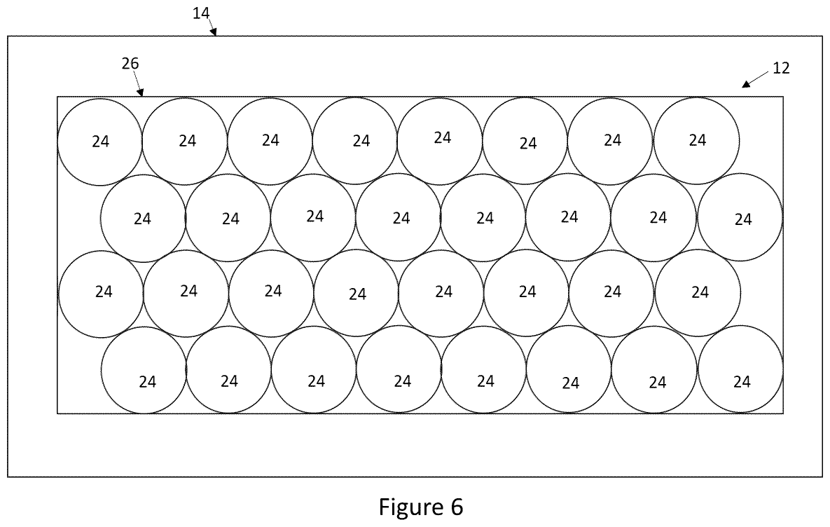

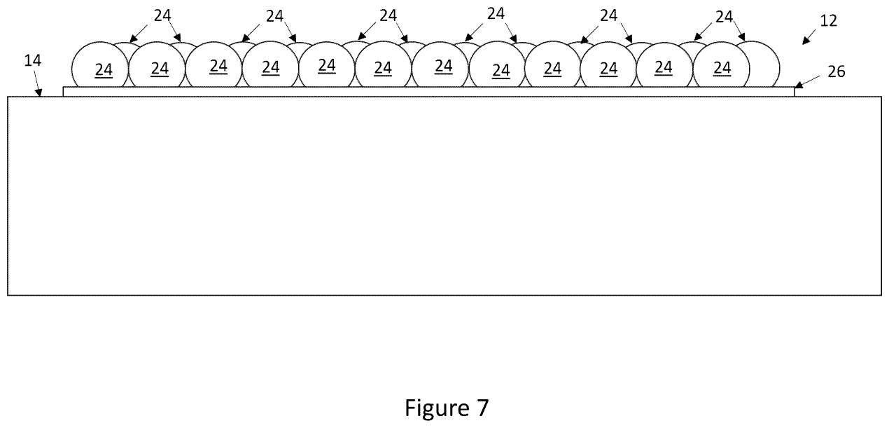

In a first example, as shown in FIGS. 6 and 7, the stabilizer 26 is formed as a relatively thin layer in which only a relatively small portion of each ball 24 is embedded or bound. Preferably, a thickness of the stabilizer 26 upon the support 14 is less than half of the average diameter of the balls 24; less than a quarter of the average diameter of the balls 24; less than a fifth of the average diameter of the balls 24; or less than a tenth of the average diameter of the balls 24.

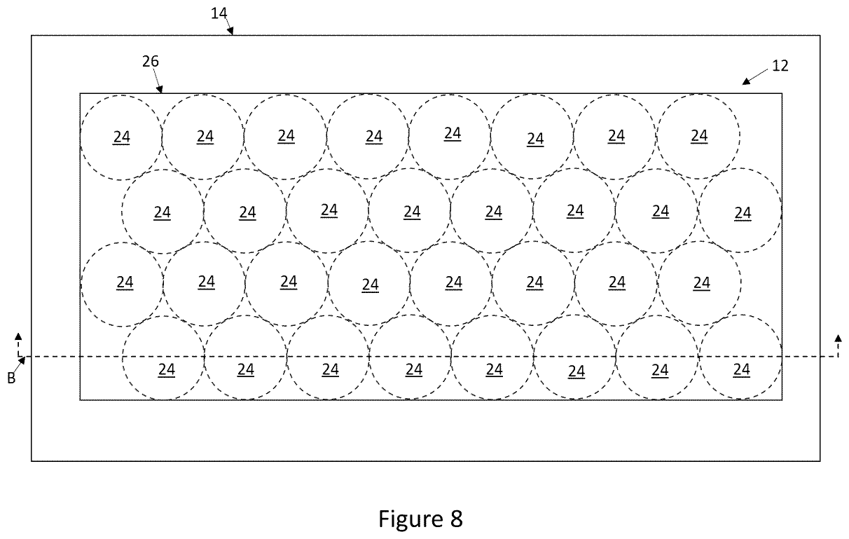

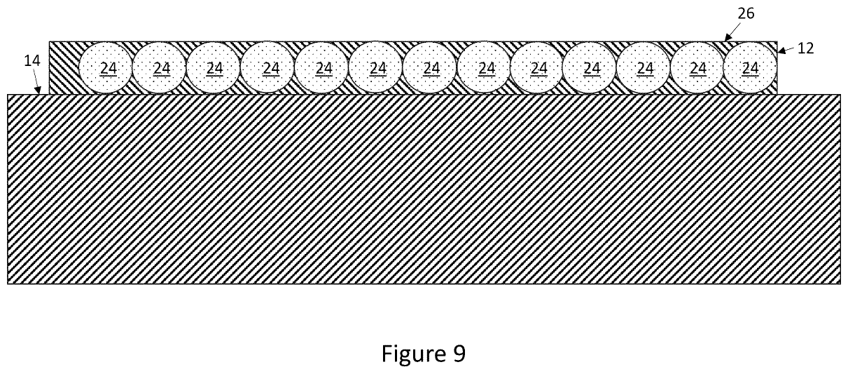

In a second example, as shown in FIGS. 8 and 9, the stabilizer 26 is formed as a layer that completely or substantially completely covers or surrounds the balls 24. For the sake of clarity, in FIG. 8, the balls 24 are shown with dashed lines so as to represent the relative position of the balls 24 within stabilizer 26. It will be understood that the visibility of the balls 24 positioned within stabilizer 26 would actually be dependent on the opacity of the stabilizer 26.

In the context of step S122, fabrication of the anti-warping layer 12 (FIG. 2), the anti-warping layer 12 of the first and second examples is formed independent of the support 14 and then in step S124 is subsequently removed from the surface upon which the anti-warping layer 12 was formed and placed upon the support 14, prior to placement of the semifinished physical object 10 upon the support 14 (S126). Alternatively, steps S122 and S124 are executed concurrently and the anti-warping layer 12 of the first example is formed directly upon the support 14, prior to placement of the semifinished physical object 10 upon the support 14 (S126).

In either case, the anti-warping layer 12 of the first example is formed by casting or otherwise spreading, spraying, or coating the stabilizer 26 across the respective surface, arranging the balls 24 within the stabilizer 26, and, as necessary depending upon the composition of stabilizer 26, providing for a hardening or curing of the formed stabilizer 26 of anti-warping layer 12 (e.g., providing time and environmental conditions). Alternatively, the anti-warping layer 12 of the first example is formed by casting or extruding a suspension comprising the balls 24 and the stabilizer 26 across the respective surface and, as necessary, depending upon the composition of stabilizer 26, providing for a hardening or curing of the formed stabilizer 26 of anti-warping layer 12 (e.g., providing time and environmental conditions). When the anti-warping layer 12 is formed from a suspension comprising the balls 24 and the stabilizer 26, the balls 24 of the suspension will settle to a lower surface of the anti-warping layer 12 due to the balls 24 having a higher density relative to a density of the stabilizer 26.

In one example, the anti-warping layer 12 is formed directly upon support 14 by application of the stabilizer 26 in the form of an adhesive or glue, e.g., a glue stick, over the desired portion of, for example, an alumina support 14. The layer of the stabilizer 26 is manipulated by use of, for example, a razor blade, to form a smooth, thin, even layer of stabilizer 26, or an adhesive layer over the surface of support 14. The balls 24 are then spread over the stabilizer 26 to form a packed, monolayer of balls 24 over or embedded in the stabilizer 26. The semifinished physical object 10 is then placed directly upon the formed anti-warping layer 12. The support 14 with the anti-warping layer 12 and semifinished physical object 10 are then placed in the treatment apparatus 16 and subjected to the volumetric change treatment or treatments.

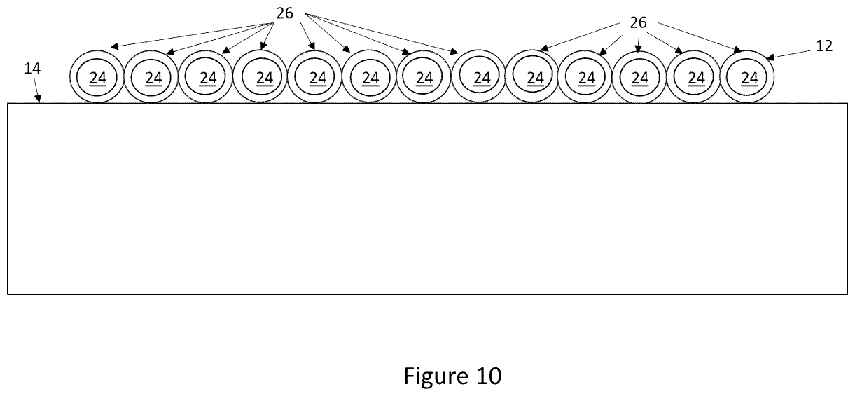

In a third example, as shown in FIG. 10, the stabilizer 26 is employed to coat or otherwise form an exterior layer around the individual balls 24. In the context of the steps S122 and S124, fabrication of the anti-warping layer 12 and arrangement of the anti-warping layer upon the support (FIG. 2), the stabilizer 26 coated balls 24 are formed independent of the support 14 and then subsequently placed upon the support 14, prior to placement of the semifinished physical object 10 upon the support 14 (S126). For example, prior to placement of the balls 24 upon support 14, the balls 24 are completely or partially coated in stabilizer 26 by spraying, dipping, or any other suitable coating technique and then, as necessary depending upon the composition of stabilizer 26, hardened or cured (e.g., by providing time and environmental conditions). Such stabilizer 26 coated balls 24 can then be arranged or placed upon the support 14, prior to placement of the semifinished physical object 10 upon the stage or support 14 (S124).

In a variation of the third example in which steps S122 and S124 are executed concurrently, the stabilizer 26 coated balls 24 are formed directly upon the stage or support 14, prior to placement of the semifinished physical object 10 upon the support 14 (S126). In the context of steps S122 and S124 (FIG. 2), the balls 24 are coated in stabilizer 26 by first arranging the balls 24 upon the upper surface 18 of the support 14 and then spraying or pouring the stabilizer 26 over the balls 24. As necessary, depending upon the composition of stabilizer 26, a hardening or curing step can then be performed (e.g., by providing time and environmental conditions).

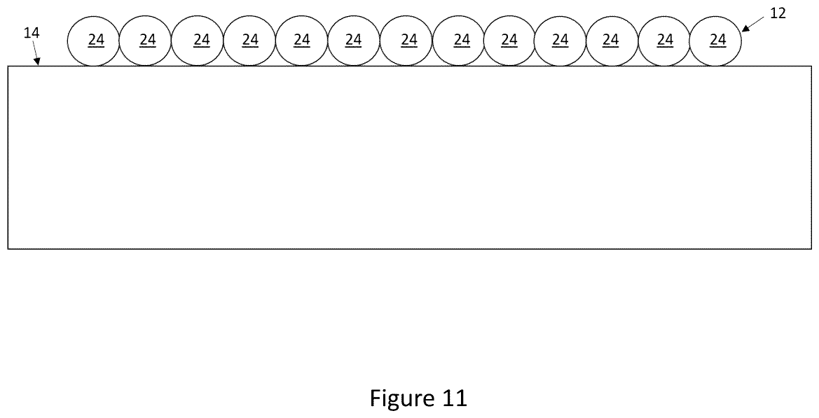

In a fourth example, as shown in FIG. 11, stabilizer 26 is not employed in the anti-warping layer 12. In examples in which stabilizer 26 is not employed in the anti-warping layer 12, it may be advantageous to employ the support 14 configuration shown in FIG. 5 having the lip 22 that may assist in limiting the motion of the balls 24 relative to the support 14 during movement of the support 14. In the context of step S122, fabrication of the anti-warping layer 12 and step S124 arrangement of anti-warping layer upon support (FIG. 2), the balls 24 are simply arranged in the desired location upon the upper surface 18 of the support 14, prior to placement of the semifinished physical object 10 upon the stage or support 14 (S126).

### Method 200

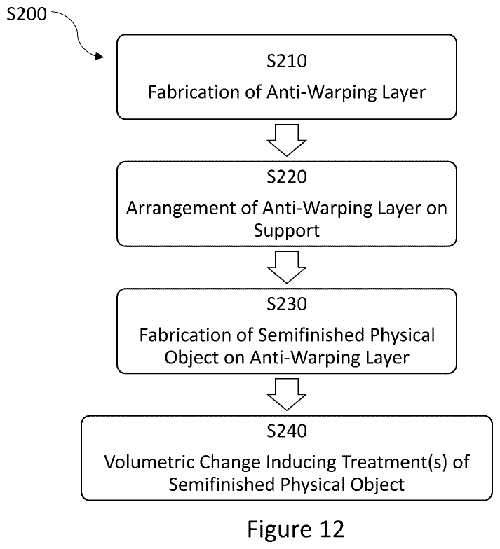

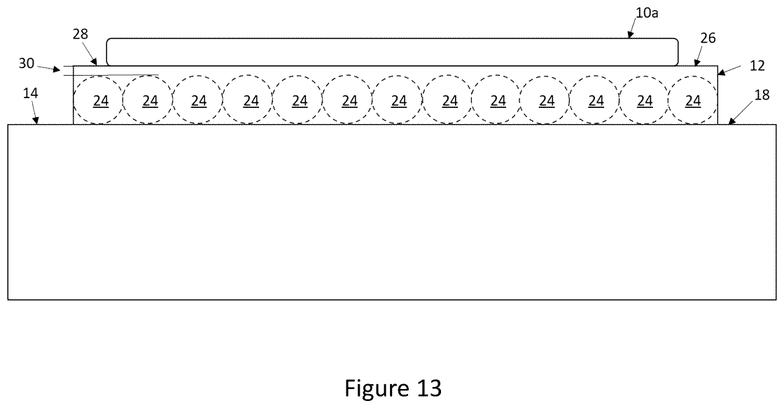

In an alternative example of the present disclosure, shown in FIGS. 12 and 13, the anti-warping layer is fabricated, arranged onto a surface of the support, and the physical object is subsequently fabricated directly upon an upper surface of the anti-warping layer. FIG. 12, illustrates a method 200 for minimizing warpage of a finished physical object according to one example of the present disclosure. Exemplary method 200 employs steps: S210 for fabrication of an anti-warping layer; S220 for arrangement of the anti-warping layer on the support; S230 for fabrication of a semifinished physical object on the anti-warping layer; and S240 for volumetric change inducing treatment or treatments of the semifinished physical object.

FIG. 13 shows an elevation view of the anti-warping layer 12 formed upon the upper surface 18 of support 14. Fabricated upon the upper surface 28 of the anti-warping layer 12 of FIG. 13 is an initial portion of a physical object 10a.

For the present example, the composition of the stabilizer 26 is as previously described herein or is a composition that has a lower melting point or decomposition point than the material from which the physical object is fabricated, that is more volatile than the material from which the physical object is fabricated, that is more brittle than the material from which the physical object is fabricated, or that has any other suitable physical properties relative to the material from which the physical object is fabricated. Such compositions include carbonaceous microparticles (e.g., graphite, carbon black), polymers (e.g., plastics, gels), carbon steel, ceramic, sand, carbon, silica, alumina, boron. Additional compositions are described in U.S. Publication No. 2022/0339703, entitled System and Method for Additive Metal Manufacturing, filed Jun. 28, 2022, herein incorporated in its entirety by reference.

In the context of step S210, fabrication of the anti-warping layer of method 200 (FIG. 12), the anti-warping layer is formed according to any of the methods described herein for formation of the anti-warping layer 12. As described herein with respect to method 100 and steps S122 and S124, step S210, fabrication of the anti-warping layer, and step S220, arrangement of the anti-warping layer on the support, can be executed concurrently or in sequence.

With reference to FIG. 13, during step S210 in which an anti-warping layer 12 is fabricated, it may be desirable to create a thickness 30 of the stabilizer 26 that extends above a height of the balls 24. The thickness 30 of stabilizer 26 provides excess stabilizer 26 that can be removed, e.g., by machining and without contacting, disturbing, or damaging balls 24. Such removal of excess stabilizer 26 may facilitate the formation of a smooth, planar upper surface 28 of the anti-warping layer 12 upon which the physical object 10 is to be fabricated. For the sake of clarity, in FIG. 13, the balls 24 are shown with dashed lines so as to represent the position of the balls 24 within stabilizer 26. It will be understood that the visibility of the balls 24 positioned within stabilizer 26 would actually be dependent on the opacity of the stabilizer 26.

In the context of step S240, the volumetric change inducing treatment or treatments of the semifinished physical object of method 200 (FIG. 12), the stabilizer 26 decomposes or melts at temperatures lower than the temperature of the volumetric change inducing treatment or treatments and/or at temperatures lower than the decomposition temperature of the binder or binders employed in the material from which the physical object is formed. Accordingly, the balls 24 of layer 12 are exposed and/or otherwise permitted to support the physical object 10 on the support 14 during the remainder of the volumetric change inducing treatment or treatments (S240).

For example, method 200 is implemented through the techniques and systems described in U.S. Pat. Nos. 10,087,332, 10,520,923; 10,807,162; 11,306,968; and U.S. Pub. Nos.: 2022/0097190; 2022/0331873; 2022/0339703; 2023/0057940; which are each herein incorporated by reference in their entireties.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. An anti-warping layer comprising:
a semifinished physical object comprising a bottom surface;
a support comprising a top surface, wherein the bottom surface of the semifinished physical object is disposed over a top surface of the support; and
a mobile layer formed of one or more materials, the mobile layer interposed between a bottom surface of the semifinished physical object and a top surface of the support.

2. The anti-warping layer of claim 1 wherein the mobile layer comprises a plurality of balls.

3. The anti-warping layer of claim 1 wherein the mobile layer comprises a plurality of balls arranged in a monolayer.

4. The anti-warping layer of claim 1 wherein:
the mobile layer comprises a plurality of balls that rest directly upon the top surface of the support; and
the bottom surface of the semifinished physical object directly rests upon the plurality of balls.

5. The anti-warping layer of claim 1 wherein the mobile layer comprises a plurality of balls having an average diameter in a range of, 0.1 to 2.0 millimeters, 0.1 to 1.0 millimeters, 0.1 to 0.8 millimeters, 0.2 to 0.8 millimeters, 0.2 to 0.6 millimeters, 0.2 to 0.3 millimeters, 0.3 to 0.4 millimeters, 0.4 to 0.6 millimeters, or 0.4 to 0.5 millimeters.

6. The anti-warping layer of claim 1 wherein the mobile layer comprises a plurality of balls, wherein individual balls of the plurality of balls are formed of or coated with a material comprising zirconium dioxide, yttria-stabilized zirconia, ceria-stabilized zirconia, yttria, aluminum oxide, silicon dioxide, calcium oxide, carbon, graphite, silicon carbide, tungsten carbide, boron nitride, porcelain and/or combinations thereof.

7. The anti-warping layer of claim 1 wherein the mobile layer comprises a plurality of balls and a stabilizer that temporarily limits mobility of individual balls of the plurality of balls relative to the support.

8. The anti-warping layer of claim 1 wherein the mobile layer comprises a stabilizer that decomposes at a temperature ranging from 150 degrees Celsius to 400 degrees Celsius.

9. The anti-warping layer of claim 1 wherein the mobile layer comprises a stabilizer, the stabilizer comprising polycarbonate, poly(ethylene carbonate), poly(propylene carbonate), (poly)acrylic acid, polyethylene glycol, polyvinyl alcohol, ethyl cellulose, adhesives, or a combination thereof.

10. The anti-warping layer of claim 1 wherein the mobile layer comprises a plurality of balls and a stabilizer, the stabilizer having a thickness that is less than half of an average diameter of the plurality of balls; less than a quarter of an average diameter of the plurality of balls; less than a fifth of the average diameter of the plurality of balls; or less than a tenth of the average diameter of the plurality of balls.

11. The anti-warping layer of claim 1 wherein the mobile layer comprises a plurality of balls and a stabilizer, the stabilizer coating at least a portion of a surface of each individual ball of the plurality of balls.

12. The anti-warping layer of claim 1 wherein the mobile layer comprises a plurality of balls and a stabilizer, the stabilizer forming a thickness greater than an average diameter of the plurality of balls.

13. A method for minimizing warpage of a physical object during a volumetric change inducing treatment comprising
forming an anti-warping layer;
arranging the anti-warping layer on an upper surface of a support;
placing a semifinished physical object such that it is disposed over an upper surface of the anti-warping layer; and
subjecting the semifinished physical object to a volumetric change inducing treatment while disposed over the anti-warping layer and the support.

14. The method of claim 13 wherein the step of forming the anti-warping layer and the step of arranging the anti-warping layer on the upper surface of a support are executed concurrently.

15. The method of claim 13 wherein the step of forming the anti-warping layer comprises casting, spreading, spraying, or coating a stabilizer on to a surface and arranging a plurality of balls within the stabilizer.

16. The method of claim 13 wherein the step of forming the anti-warping layer comprises arranging a plurality of balls over a surface and casting, spreading, spraying, or coating a stabilizer over the plurality of balls.

17. The method of claim 13 wherein the step of forming the anti-warping layer comprises casting or extruding a suspension comprising a stabilizer and a plurality of balls over a surface.

18. The method of claim 13 wherein the step of forming the anti-warping layer comprises applying an adhesive layer over the upper surface of the support and arrangement of a plurality of balls upon the adhesive layer.

19. The method of claim 13 wherein the step of subjecting the semifinished physical object to the volumetric change inducing treatment comprises subjecting the semifinished physical object to a thermal treatment.

20. The method of claim 13 wherein the step of placing the semifinished physical object upon the upper surface of the anti-warping layer comprises forming at least a portion of the semifinished physical object upon an upper surface of the anti-warping layer.
